(19) United States
(12) Patent Application Publication
(10) Pub. No.: US 2023/0382805 A1
(43) Pub. Date: Nov. 30, 2023

(54) SINTERING-RESISTANT MATERIAL, AND PREPARATION METHOD AND USE THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Haijun Yu, Foshan (CN); Yingsheng Zhong, Foshan (CN); Aixia Li, Foshan (CN); Yinghao Xie, Foshan (CN); Xuemei Zhang, Foshan (CN)

(21) Appl. No.: 18/231,798

(22) Filed: Aug. 9, 2023

Related U.S. Application Data
(63) Continuation of application No. PCT/CN2022/093594, filed on May 18, 2022.

(30) Foreign Application Priority Data
Aug. 23, 2021 (CN) 202110968476.4

(51) Int. Cl. C04B 35/04; C04B 35/622; C04B 35/63; C04B 35/64; H01M 10/54

(52) U.S. Cl. CPC C04B 35/04; C04B 35/62204; C04B 35/6316; C04B 35/64; H01M 10/54; C04B 2235/3418; C04B 2235/3206; C04B 2235/448; C04B 2235/425; C04B 2235/3817; C04B 2235/402; C04B 2235/444; C04B 2235/604; C04B 2235/9669

(57) ABSTRACT

The present disclosure discloses a sintering-resistant material, and a preparation method and use thereof. The sintering-resistant material includes magnesium oxide, an anti-corrosive agent, an antioxidant, and a binder, where the anti-corrosive agent includes a barite powder and a porous graphite powder; the antioxidant includes aluminum carbide and an aluminum powder; the binder includes a metal chloride and a silica sol; and metals in the raw materials are all extracted from a hydrochloric acid leachate of an electric furnace slag. In the present disclosure, the preparation method of the present disclosure improves the resource utilization of the electric furnace slag. Magnesium and aluminum have the largest proportion among metal elements in the electric furnace slag, and thus magnesium oxide is used as the main material. In addition, other chloride salts leached out from the electric furnace slag by hydrochloric acid can be directly or indirectly used.

### CROSS-REFERENCE TO RELATED APPLICATIONS

The present application is a continuation application of PCT application No. PCT/CN2022/093594 filed on May 18, 2022, which claims the benefit of Chinese Patent Application No. 202110968476.4 filed on Aug. 23, 2021. The contents of all of the aforementioned applications are incorporated by reference herein in their entirety.

### TECHNICAL FIELD

The present disclosure belongs to the technical field of refractory materials, and specifically relates to a sintering-resistant material, and a preparation method and use thereof.

### BACKGROUND

Scrapped power batteries are a very important reusable resource. It is estimated that the quantity of scrapped power batteries in China will exceed 600,000 tons by 2025 and will exceed 1.5 million tons by 2030, which shows an exponential growth trend. Therefore, due to the continuous generation of scrapped power batteries, the scrapped power battery recycling industry will flourish. Contemporary Amperex Technology Co., Limited (CATL), Shanghai Automotive Industry Corporation (SAIC) Motor, Green Eco-manufacture (GEM), Build Your Dreams (BYD), Huayou Cobalt, and other companies have entered the scrapped power battery recycling industry chain.

At present, the fire-wet recycling technology is the mainstream recycling technology for scrapped power batteries, and includes the following steps: dismantling, discharging, crushing, roasting, screening, leaching, impurity removal, extraction, synthesis, and the like, which mainly aims to recover heavy metal elements such as nickel, cobalt, manganese, and lithium in scrapped power batteries and by-products such as aluminum, copper, iron, and graphite. However, when cathode materials of scrapped power batteries are roasted, a considerable proportion of organic solvents such as polyvinylidene fluoride (PVDF), ethylene carbonate (EC), dimethyl carbonate (DMC), lithium hexafluorophosphate (LHFP), lithium tetrafluoroborate (LTFB), and lithium hexafluoroarsenate (LHFA) in the scrapped power batteries is decomposed at a high temperature to produce harmful substances, which directly affect the recycling equipment, and cause particularly obvious damage to sintering-resistant materials in direct contact with battery active materials especially under the conditions of high temperature, high pressure, complex reaction, and the like.

Sintering-resistant materials for the recycling of scrapped power batteries are mostly SiC composite materials, high-MgO materials, and SiO₂—Al₂O₃ materials, and the substances produced from the high-temperature decomposition of the organic solvents can easily react with MgO, Al₂O₃, and SiO₂ to make a sintering-resistant material of a rotary kiln corroded and penetrated, thereby causing the sintering-resistant material to fall off and crack. At a high temperature, some reaction principles can be expressed by the following reaction equations:

LiPF₆→PF₅+LiF

LiPF₆+H₂O→OPF₃+LiF+2HF

LiF+H₂O→HF+Li₂O

2HF+MgO→MgF₂+H₂O

4HF+SiO₂→SiF₄+2H₂O

SiC+4HF→SiF₄+CH₄

6HF+Al₂O₃→2AlF₃+3H₂O

Moreover, the annual discharge of electric furnace slags from smelting in China exceeds 30 million tons. Generally, the electric furnace slags are deeply buried, processed into building materials, and dumped in the open air, and thus the comprehensive utilization of electric furnace slags is low. It is relatively rare to prepare a sintering-resistant material using metals extracted from an electric furnace slag and use the sintering-resistant material for the recycling of scrapped power batteries.

### SUMMARY OF THE INVENTION

The present disclosure is intended to solve at least one of the technical problems existing in the prior art. In view of this, the present disclosure provides a sintering-resistant material, and a preparation method and use thereof.

According to one aspect of the present disclosure, a sintering-resistant material is provided, including the following raw materials: magnesium oxide, an anti-corrosive agent, an antioxidant, and a binder, where the anti-corrosive agent includes a barite powder and a porous graphite powder; the antioxidant includes aluminum carbide and an aluminum powder; and the binder includes a metal chloride and a silica sol.

In some implementations of the present disclosure, the magnesium oxide, the anti-corrosive agent, the antioxidant, and the binder may be at a mass ratio of (80-150):(1-15):(1-10):(0.1-10) and preferably 110:3.5:2.0:2.5.

In some implementations of the present disclosure, a mass ratio of the barite powder to the porous graphite powder may be (80-150):(1-10) and preferably (100-120):(7-10).

In some implementations of the present disclosure, a mass ratio of the aluminum carbide to the aluminum powder may be (20-100):(1-30). The aluminum carbide has relatively strong oxidation resistance, and the aluminum carbide has a large proportion in the antioxidant, which enhances the oxidation resistance of the sintering-resistant material.

In some implementations of the present disclosure, a mass ratio of the metal chloride to the silica sol may be 10:(1-5); and the metal chloride may be one or more from the group consisting of iron chloride, chromium chloride, zinc chloride, cobalt chloride, and nickel chloride.

The present disclosure also provides a preparation method of the sintering-resistant material described above, where metals in the raw materials are all extracted from an electric furnace slag, and the preparation method specifically includes the following steps:
mixing an electric furnace slag powder with hydrochloric acid for acid leaching, and conducting solid-liquid separation (SLS) to obtain a leachate, where salts in the leachate mainly include magnesium chloride, iron chloride, and aluminum chloride; and an insoluble residue obtained from the SLS is a silicon residue, which is silicon dioxide;
evaporating hydrogen chloride from the leachate to obtain a chloride salt solution, adjusting the pH of the chloride salt solution with an alkali liquor to precipitate aluminum hydroxide and magnesium hydroxide separately, and evaporating a resulting chloride salt solution after the precipitation to obtain a chloride salt crystal;
subjecting the magnesium hydroxide to dehydration at a high temperature to obtain the magnesium oxide; subjecting the chloride salt crystal to dehydration at a high temperature to obtain a metal chloride; and subjecting the aluminum hydroxide to a reaction with a reducing agent to obtain aluminum, and mixing the aluminum with powdered carbon to allow a reaction to obtain the antioxidant;
mixing the barite powder and the porous graphite powder to obtain the anti-corrosive agent, and mixing the metal chloride with the silica sol to obtain the binder; and
mixing the magnesium oxide, the anti-corrosive agent, the antioxidant, and the binder in proportion to obtain a mixture, pressing the mixture into a blank, and heating the blank in an inert atmosphere to obtain the sintering-resistant material.

In some implementations of the present disclosure, a solid-to-liquid ratio of the electric furnace slag powder to the hydrochloric acid may be 10:(40-80) (g/mL); and preferably, the hydrochloric acid may have a concentration of 8 mol/L to 12 mol/L. Further, the acid leaching may be conducted for 30 min to 40 min.

In some implementations of the present disclosure, after the acid leaching is completed and before the SLS, a slurry obtained by the acid leaching may be washed with hot water of 50° C. to 95° C., and a volume ratio of the slurry to the hot water may be 1:(7.5-10).

In some implementations of the present disclosure, the hydrogen chloride may be evaporated at 70° C. to 95° C. until a volume of the leachate is reduced by 200 ml/L to 400 ml/L.

In some implementations of the present disclosure, the aluminum hydroxide may be precipitated out at a pH of 3.0 to 4.8 and preferably 3.50; and the magnesium hydroxide may be precipitated out at a pH of 9.0 to 10.5 and preferably 9.40.

In some implementations of the present disclosure, the alkali liquor may be one or more from the group consisting of a sodium hydroxide solution, a potassium hydroxide solution, a magnesium hydroxide solution, and a calcium hydroxide solution, and the alkali liquor may have a concentration of 0.05 mol/L to 2 mol/L.

In some implementations of the present disclosure, the magnesium hydroxide and/or the chloride salt crystal may be subjected to dehydration for 30 min to 40 min at 180° C. to 300° C. The obtained magnesium oxide is anhydrous magnesium oxide.

In some implementations of the present disclosure, the reducing agent may be one or more from the group consisting of powdered carbon, pulverized coal, carbon monoxide, hydrogen, and hydrogen sulfide; and the reaction of the aluminum hydroxide with the reducing agent may be conducted at preferably 600° C. to 1,100° C. and more preferably 850° C. to 1,000° C.

In some implementations of the present disclosure, the aluminum may be ball-milled into an aluminum powder before reacting with the powdered carbon, and in the aluminum powder and/or the powdered carbon, more than 90% of particles may have a particle size of <300 μm and preferably <175 μm.

In some implementations of the present disclosure, the reaction of the aluminum with the powdered carbon may be conducted for 200 min to 400 min at 800° C. to 1,400° C. in a protective atmosphere; and a gas for the protective atmosphere may be one from the group consisting of argon, helium, and neon.

In some implementations of the present disclosure, more than 90% of the particles of the porous graphite powder and/or the barite powder may have a particle size of <150 μm and preferably <85 μm.

In some implementations of the present disclosure, the blank may be heated at 1,140° C. to 1,450° C. for 150 min to 450 min in an inert atmosphere, and an inert gas for the inert atmosphere may be one from the group consisting of nitrogen, helium, neon, and argon.

The present disclosure also provides use of the sintering-resistant material described above in the recycling of a scrapped power battery, which specifically refers to use in a sintering device for roasting a cathode material of a scrapped power battery. Further, the sintering device may be a rotary kiln.

According to a preferred implementation of the present disclosure, the present disclosure at least has the following beneficial effects:
1. The present disclosure uses the anti-corrosive agent to improve the corrosion resistance and strength of the sintering-resistant material. In order to prevent fluorine in PVDF, LHFP, LTFB, LHFA, and the like from corroding the sintering-resistant material, a large amount of barite powder is added into the anti-corrosive agent. The barite powder has high-temperature resistance and corrosion resistance, which allows magnesium oxide to be wrapped by a protective layer through mixing and coating. The well-developed pores of the porous graphite can provide buffer spaces for a volume change of the material after being heated, which well solves the problem that a sintering-resistant material will expand at a high temperature due to the volume increase of magnesium oxide.
2. The present disclosure uses the composite antioxidant to enhance the oxidation resistance. When an electrode material is roasted, oxygen must be introduced to conduct oxidative pyrolysis to remove organic solvents. Therefore, a sintering-resistant material on an inner wall of a rotary kiln is easily oxidized, and a structure of a sintering-resistant brick is more likely to become brittle, which makes sintering-resistant materials have high requirements for oxidation resistance. In the present disclosure, a composite antioxidant of aluminum carbide-aluminum powder is added for antioxidation. Aluminum has a specified reducibility, aluminum carbide has relatively strong oxidation resistance, and the combination of the two can enhance the oxidation resistance of the sintering-resistant material.
3. The preparation method of the present disclosure improves the resource utilization of an electric furnace slag. Magnesium and aluminum have the largest proportion among metal elements in the electric furnace slag, and thus magnesium oxide is used as the main material, which not only achieves the resource utilization, but also provides a source of the main material. Moreover, an aluminum powder obtained from reduction is used to prepare the composite antioxidant of aluminum carbide-aluminum powder, which provides a source of the main material for the antioxidant in the sintering-resistant material. In addition, a prepared metal chloride can be used as a raw material for the binder. In summary, the chloride salt leached out from the electric furnace slag by hydrochloric acid can be used directly or indirectly. In addition, the electric furnace slag includes a large amount of silicon-based oxides. If the electric furnace slag is directly used to prepare a sintering-resistant material, a resulting material will have a reduced compressive strength. In the present disclosure, the electric furnace slag is not directly used to prepare a sintering-resistant material, but the silicon-based oxides are first removed through acid leaching first and then metals therein are used, and thus a resulting material has an increased compressive strength.

### BRIEF DESCRIPTION OF THE DRAWINGS

The present disclosure is further described below with reference to accompanying drawings and examples.

FIG. 1 is a process flow diagram of Example 1 of the present disclosure; and

FIG. 2 is a scanning electron microscopy (SEM) image of the electric furnace slag in Example 1 of the present disclosure;

FIG. 3 is an SEM image of the sintering-resistant material of Example 1 of the present disclosure; and

FIG. 4 is an SEM image of the sintering-resistant material of Comparative Example 1 of the present disclosure.

### DETAILED DESCRIPTION OF ILLUSTRATED EXAMPLES

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

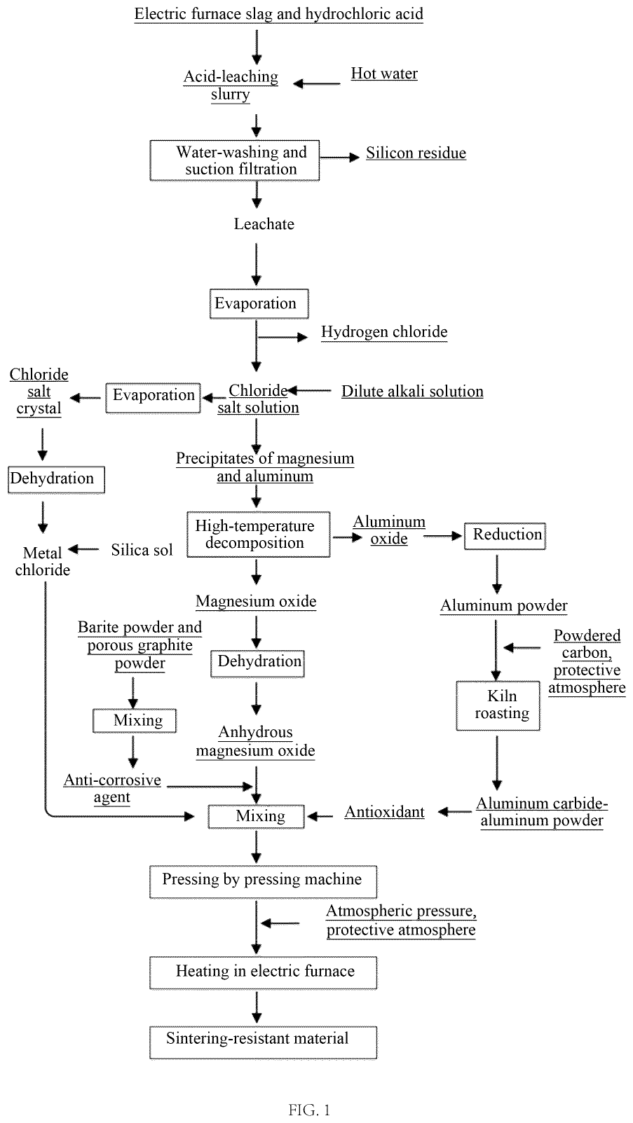

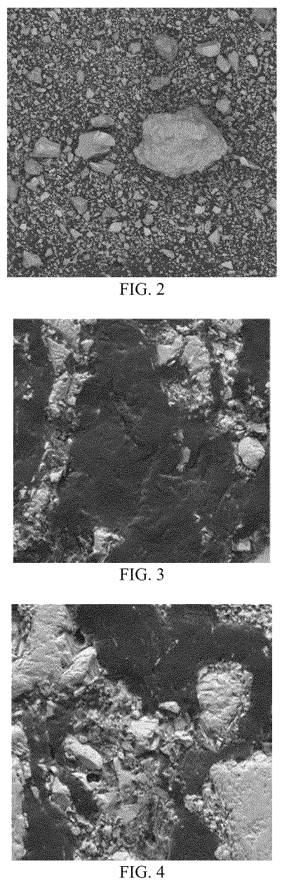

In this example, a sintering-resistant material was prepared. The sintering-resistant material was composed of magnesium oxide, an anti-corrosive agent, an antioxidant, and a binder in a mass ratio of 110:4.5:2.0:2.5. The anti-corrosive agent was composed of a barite powder and a porous graphite powder in a mass ratio of 110:7.5; the antioxidant was composed of aluminum carbide and an aluminum powder in a mass ratio of 35:3.7; and the binder was composed of a metal chloride and a silica sol in a mass ratio of 10:1.2, and the metal chloride included iron chloride, chromium chloride, zinc chloride, cobalt chloride, and nickel chloride. As shown in FIG. 1, a specific preparation process was as follows:
(1) Leaching of an electric furnace slag powder: The electric furnace slag powder was mixed with 9.3 mol/L hydrochloric acid in a solid-to-liquid ratio of 10:55 (g/mL), and a resulting electric furnace slag slurry was stirred to allow a reaction for 36 min to obtain an acid-leaching slurry; and the acid-leaching slurry was cooled, washed twice with hot water at about 63° C. (where a volume ratio of the acid-leaching slurry to the hot water was 100:850 each time), and then subjected to suction filtration to obtain a leachate and an insoluble residue, where the insoluble residue was a silicon residue (silicon dioxide) and salts in the leachate were magnesium chloride, iron chloride, aluminum chloride, chromium chloride, zinc chloride, cobalt chloride, and nickel chloride.
(2) Recovery of hydrolysates from the leachate: The leachate was delivered to an evaporation device, and hydrogen chloride was evaporated at about 90° C. until a volume of the leachate was reduced by about 280 ml/L to obtain a chloride salt solution; by adding a sodium hydroxide solution with a concentration of 0.15 mol/L, a pH of the chloride salt solution was first adjusted to 3.62 to recover an aluminum hydroxide precipitate and then adjusted to 9.57 to recover a magnesium hydroxide precipitate; and a resulting chloride salt solution was subjected to evaporation to obtain a chloride salt crystal.
(3) Preparation of the composite antioxidant, the magnesium oxide, and the metal chloride: The magnesium hydroxide and the chloride salt crystal were separately subjected to dehydration at 245° C. for 32 min in a kiln to obtain anhydrous magnesium oxide and a metal chloride; and the aluminum hydroxide was reduced by powdered carbon at about 1,020° C. in a kiln to obtain aluminum, the aluminum was ball-milled into an aluminum powder and then mixed with an appropriate amount of powdered carbon, and a resulting mixture was subjected to a reaction for 240 min at about 860° C. in an argon atmosphere in a furnace to obtain the aluminum carbide-aluminum powder composite antioxidant, where a mass ratio of the aluminum carbide to the aluminum powder was 3:1.
(4) Preparation of the anti-corrosive agent and the binder: The barite powder and the porous graphite powder were mixed in a drying mixer at a mass ratio of 110:7.5 to obtain the anti-corrosive agent, and the metal chloride and the silica sol were mixed at a mass ratio of 10:1.2 to obtain the binder.
(5) Preparation of the sintering-resistant material: The anhydrous magnesium oxide, the anti-corrosive agent, the antioxidant, and the binder were mixed in a mixer at a mass ratio of 110:4.5:2.0:2.5 to obtain a mixture, where the materials were mixed specifically as follows: the magnesium oxide and the anti-corrosive agent were thoroughly mixed, then the antioxidant and the binder were added, and a resulting mixture was thoroughly mixed; the mixture was pressed into a blank in a pressing machine; and in a nitrogen atmosphere, the blank was heated to about 1,380° C. and kept at the temperature for 180 min in an electric induction furnace to obtain the sintering-resistant material. Referring to FIG. 2 and FIG. 3, they are a scanning electron microscopy (SEM) image of the electric furnace slag and an SEM image of the sintering-resistant material of Example 1 respectively.

### Example 2

In this example, a sintering-resistant material was prepared. The sintering-resistant material was composed of magnesium oxide, an anti-corrosive agent, an antioxidant, and a binder in a mass ratio of 100:3.5:2.5:1.0. The anti-corrosive agent was composed of a barite powder and a porous graphite powder in a mass ratio of 100:7.5; the antioxidant was composed of aluminum carbide and an aluminum powder in a mass ratio of 33:6.1; and the binder was composed of a metal chloride and a silica sol in a mass ratio of 10:1.5, and the metal chloride included iron chloride, chromium chloride, zinc chloride, cobalt chloride, and nickel chloride. A specific preparation process was as follows:
(1) Leaching of an electric furnace slag powder: The electric furnace slag powder was mixed with 9.5 mol/L hydrochloric acid in a solid-to-liquid ratio of 10:55 (g/mL), and a resulting electric furnace slag slurry was stirred to allow a reaction for 40 min to obtain an acid-leaching slurry; and the acid-leaching slurry was cooled, washed twice with hot water at about 75° C. (where a volume ratio of the acid-leaching slurry to the hot water was 100:860 each time), and then subjected to suction filtration to obtain a leachate and an insoluble residue, where the insoluble residue was a silicon residue (silicon dioxide) and salts in the leachate were magnesium chloride, iron chloride, aluminum chloride, chromium chloride, zinc chloride, cobalt chloride, and nickel chloride.
(2) Recovery of hydrolysates from the leachate: The leachate was delivered to an evaporation device, and hydrogen chloride was evaporated at about 82° C. until a volume of the leachate was reduced by about 340 ml/L to obtain a chloride salt solution; by adding a sodium hydroxide solution with a concentration of 0.50 mol/L, a pH of the chloride salt solution was first adjusted to 3.87 to recover an aluminum hydroxide precipitate and then adjusted to 9.68 to recover a magnesium hydroxide precipitate; and a resulting chloride salt solution was subjected to evaporation to obtain a chloride salt crystal.
(3) Preparation of the composite antioxidant, the magnesium oxide, and the metal chloride: The magnesium hydroxide and the chloride salt crystal were separately subjected to dehydration at 270° C. for 36 min in a drying oven to obtain anhydrous magnesium oxide and a metal chloride; and the aluminum hydroxide was reduced by pulverized coal at about 1,020° C. in a kiln to obtain aluminum, the aluminum was ball-milled into an aluminum powder and then mixed with an appropriate amount of powdered carbon, and a resulting mixture was subjected to a reaction for 300 min at about 980° C. in an argon atmosphere in a furnace to obtain the aluminum carbide-aluminum powder composite antioxidant, where a mass ratio of the aluminum carbide to the aluminum powder was 7:2.
(4) Preparation of the anti-corrosive agent and the binder: The barite powder and the porous graphite powder were mixed in a drying mixer at a mass ratio of 100:7.5 to obtain the anti-corrosive agent, and the metal chloride and the silica sol were mixed at a mass ratio of 10:1.5 to obtain the binder.
(5) Preparation of the sintering-resistant material: The anhydrous magnesium oxide, the anti-corrosive agent, the antioxidant, and the binder were mixed in a mixer at a mass ratio of 100:3.5:2.5:1.0 to obtain a mixture, where the materials were mixed specifically as follows: the magnesium oxide and the anti-corrosive agent were thoroughly mixed, then the antioxidant and the binder were added, and a resulting mixture was thoroughly mixed; the mixture was pressed into a blank in a pressing machine; and in a nitrogen atmosphere, the blank was heated to about 1,450° C. and kept at the temperature for 200 min in an electric induction furnace to obtain the sintering-resistant material.

### Example 3

In this example, a sintering-resistant material was prepared. The sintering-resistant material was composed of magnesium oxide, an anti-corrosive agent, an antioxidant, and a binder in a mass ratio of 120:5.5:2.5:3.5. The anti-corrosive agent was composed of a barite powder and a porous graphite powder in a mass ratio of 120:7.5; the antioxidant was composed of aluminum carbide and an aluminum powder in a mass ratio of 48:14.5; and the binder was composed of a metal chloride and a silica sol in a mass ratio of 10:1.8, and the metal chloride included iron chloride, chromium chloride, zinc chloride, cobalt chloride, and nickel chloride. A specific preparation process was as follows:
(1) Leaching of an electric furnace slag powder: The electric furnace slag powder was mixed with 9.3 mol/L hydrochloric acid in a solid-to-liquid ratio of 10:70 (g/mL), and a resulting electric furnace slag slurry was stirred to allow a reaction for 35 min to obtain an acid-leaching slurry; and the acid-leaching slurry was cooled, washed twice with hot water at about 88° C. (where a volume ratio of the acid-leaching slurry to the hot water was 100:920 each time), and then subjected to suction filtration to obtain a leachate and an insoluble residue, where the insoluble residue was a silicon residue (silicon dioxide) and salts in the leachate were magnesium chloride, iron chloride, aluminum chloride, chromium chloride, zinc chloride, cobalt chloride, and nickel chloride.
(2) Recovery of hydrolysates from the leachate: The leachate was delivered to an evaporation device, and hydrogen chloride was evaporated at about 95° C. until a volume of the leachate was reduced by about 330 ml/L to obtain a chloride salt solution; by adding a sodium hydroxide solution with a concentration of 0.30 mol/L, a pH of the chloride salt solution was first adjusted to 3.83 to recover an aluminum hydroxide precipitate and then adjusted to 9.74 to recover a magnesium hydroxide precipitate; and a resulting chloride salt solution was subjected to evaporation to obtain a chloride salt crystal.
(3) Preparation of the composite antioxidant, the magnesium oxide, and the metal chloride: The magnesium hydroxide and the chloride salt crystal were separately subjected to dehydration at 285° C. for 36 min in a drying oven to obtain anhydrous magnesium oxide and a metal chloride; and the aluminum hydroxide was reduced by pulverized coal at about 1,050° C. in a kiln to obtain aluminum, the aluminum was ball-milled into an aluminum powder and then mixed with an appropriate amount of powdered carbon, and a resulting mixture was subjected to a reaction for 360 min at about 1,345° C. in an argon atmosphere in a furnace to obtain the aluminum carbide-aluminum powder composite antioxidant, where a mass ratio of the aluminum carbide to the aluminum powder was 5:1.
(4) Preparation of the anti-corrosive agent and the binder: The barite powder and the porous graphite powder were mixed in a drying mixer at a mass ratio of 120:7.5 to obtain the anti-corrosive agent, and the metal chloride and the silica sol were mixed at a mass ratio of 10:1.8 to obtain the binder.
(5) Preparation of the sintering-resistant material: The anhydrous magnesium oxide, the anti-corrosive agent, the antioxidant, and the binder were mixed in a mixer at a mass ratio of 120:5.5:2.5:3.5 to obtain a mixture, where the materials were mixed specifically as follows: the magnesium oxide and the anti-corrosive agent were thoroughly mixed, then the antioxidant and the binder were added, and a resulting mixture was thoroughly mixed; the mixture was pressed into a blank in a pressing machine; and in a nitrogen atmosphere, the blank was heated to about 1,360° C. and kept at the temperature for 250 min in an electric induction furnace to obtain the sintering-resistant material.

### Comparative Example 1

In this comparative example, a sintering-resistant material was prepared. In a preparation process of this comparative example, the silicon residue in step (1) was used instead of the magnesium oxide to prepare the sintering-resistant material; the steps (1) to (4) were the same as in Example 1; and the step (5) was specifically as follows:
preparation of the sintering-resistant material: the silicon residue, the anti-corrosive agent, the antioxidant, and the binder were mixed in a mixer at a mass ratio of 110:4.5:2.0:2.5 to obtain a mixture, where the materials were mixed specifically as follows: the silicon residue and the anti-corrosive agent were thoroughly mixed, then the antioxidant and the binder were added, and a resulting mixture was thoroughly mixed; the mixture was pressed into a blank in a pressing machine; and in a nitrogen atmosphere, the blank was heated to about 1,380° C. and kept at the temperature for 180 min in an electric induction furnace to obtain the sintering-resistant material. Referring to FIG. 4, it is an SEM image of the sintering-resistant material of Comparative Example 1.

### Comparative Example 2

In this comparative example, a sintering-resistant material was prepared. In a preparation process of this comparative example, the silicon residue in step (1) was used instead of 85 parts among the 110 parts of magnesium oxide to prepare the sintering-resistant material; the steps (1) to (4) were the same as in Example 1; and the step (5) was specifically as follows:
preparation of the sintering-resistant material: the silicon residue, the anhydrous magnesium oxide, the anti-corrosive agent, the antioxidant, and the binder were mixed in a mixer at a mass ratio of 85:35:4.5:2.0:2.5 to obtain a mixture, where the materials were mixed specifically as follows: the silicon residue, the magnesium oxide, and the anti-corrosive agent were thoroughly mixed, then the antioxidant and the binder were added, and a resulting mixture was thoroughly mixed; the mixture was pressed into a blank in a pressing machine; and in a nitrogen atmosphere, the blank was heated to about 1,380° C. and kept at the temperature for 180 min in an electric induction furnace to obtain the sintering-resistant material.

### Comparative Example 3

In this comparative example, a sintering-resistant material was prepared. In a preparation process of this comparative example, no antioxidant was added into the sintering-resistant material; the steps (1) to (4) were the same as in Example 1; and the step (5) was specifically as follows:
preparation of the sintering-resistant material: the anhydrous magnesium oxide, the anti-corrosive agent, and the binder were mixed in a mixer at a mass ratio of 100:3.5:1.0 to obtain a mixture, where the materials were mixed specifically as follows: the magnesium oxide and the anti-corrosive agent were thoroughly mixed, then the binder was added, and a resulting mixture was thoroughly mixed; the mixture was pressed into a blank in a pressing machine; and in a nitrogen atmosphere, the blank was heated to about 1,460° C. and kept at the temperature for 180 min in an electric induction furnace to obtain the sintering-resistant material.

The sintering-resistant materials prepared in Examples 1 to 3 and Comparative Examples 1 to 3 were subjected to a sintering-resistance test in a rotary kiln. During the test, 14 batches of electrode materials were roasted at 400° C. to 900° C.

TABLE 1
Performance test of the sintering-resistant materials obtained in the
examples and comparative examples

| | | | Reduction/ | |
|---|---|---|---|---|
| | | Falling-off | (%) | Compressive |
| | | thickness/mm | Mass | strength/ |
| | | Thickness | difference | MPa |
| Test item | Density (g/cm³) | difference | before | Pressing |
| Detection | Mass-to-volume | before and after | and after | machine |
| method | ratio | sintering | sintering | test |
| Example 1 | 3.11 | 0.3-1.8 | 0.14 | 38.64 |
| Example 2 | 3.14 | 0.1-1.9 | 0.16 | 38.47 |
| Example 3 | 3.15 | 0.8-1.4 | 0.11 | 38.71 |
| Comparative | 2.87 | 1.2-5.1 | 0.34 | 34.89 |
| Example 1 | | | | |
| Comparative | 2.92 | 1.7-4.0 | 0.30 | 36.48 |
| Example 2 | | | | |
| Comparative | 3.23 | 2.3-6.5 | 0.54 | 38.35 |
| Example 3 | | | | |

It can be seen from Table 1 that Comparative Examples 1 and 2 have a lower compressive strength than the examples, and this is because Comparative Examples 1 and 2 include a large amount of silicon-based oxides, which reduces the compressive strength of the sintering-resistant material. A sintering reduction in Comparative Example 3 is significantly higher than that in the examples, resulting in a larger falling-off thickness, and this is because no antioxidant is added in Comparative Example 3, which makes the material more prone to oxidation, makes a structure of the material more likely to become brittle, and more of the material fall off after repeated roasting. In addition, Comparative Example 1 has a larger falling-off thickness and a greater reduction than Comparative Example 2, which indicates that the addition of a specified proportion of anhydrous magnesium oxide in the silicon residue as the main material can also improve the corrosion resistance and oxidation resistance to some extent.

The examples of present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples in the present disclosure or features in the examples may be combined with each other in a non-conflicting situation.

1. A sintering-resistant material, comprising the following raw materials: magnesium oxide, an anti-corrosive agent, an antioxidant, and a binder, wherein the anti-corrosive agent comprises a barite powder and a porous graphite powder; the antioxidant comprises aluminum carbide and an aluminum powder; and the binder comprises a metal chloride and a silica sol.

2. The sintering-resistant material according to claim 1, wherein the magnesium oxide, the anti-corrosive agent, the antioxidant, and the binder are at a mass ratio of (80-150):(1-15):(1-10):(0.1-10).

3. The sintering-resistant material according to claim 1, wherein a mass ratio of the barite powder to the porous graphite powder is (80-150):(1-10).

4. The sintering-resistant material according to claim 1, wherein a mass ratio of the aluminum carbide to the aluminum powder is (20-100):(1-30).

5. The sintering-resistant material according to claim 1, wherein a mass ratio of the metal chloride to the silica sol is 10:(1-5); and preferably, the metal chloride is one or more selected from the group consisting of iron chloride, chromium chloride, zinc chloride, cobalt chloride, and nickel chloride.

6. A preparation method of the sintering-resistant material according to claim 1, wherein metals in the raw materials are all extracted from an electric furnace slag, and the preparation method specifically comprises the following steps:
mixing an electric furnace slag powder with hydrochloric acid for acid leaching, and conducting solid-liquid separation to obtain a leachate;
evaporating hydrogen chloride from the leachate to obtain a chloride salt solution, adjusting the pH of the chloride salt solution with an alkali liquor to precipitate aluminum hydroxide and magnesium hydroxide separately, and evaporating a resulting chloride salt solution after the precipitation to obtain a chloride salt crystal;
subjecting the magnesium hydroxide to dehydration at a high temperature to obtain the magnesium oxide; subjecting the chloride salt crystal to dehydration at a high temperature to obtain a metal chloride; and subjecting the aluminum hydroxide to a reaction with a reducing agent to obtain aluminum, and mixing the aluminum with powdered carbon to allow a reaction to obtain the antioxidant;
mixing the barite powder and the porous graphite powder to obtain the anti-corrosive agent, and mixing the metal chloride with the silica sol to obtain the binder; and
mixing the magnesium oxide, the anti-corrosive agent, the antioxidant, and the binder in proportion to obtain a mixture, pressing the mixture into a blank, and heating the blank in an inert atmosphere to obtain the sintering-resistant material.

7. The preparation method according to claim 6, wherein a solid-to-liquid ratio of the electric furnace slag powder to the hydrochloric acid is 10:(40-80) (g/mL); and preferably, the hydrochloric acid has a concentration of 8 mol/L to 12 mol/L.

8. The preparation method according to claim 6, wherein the aluminum hydroxide is precipitated out at a pH of 3.0 to 4.8; and the magnesium hydroxide is precipitated out at a pH of 9.0 to 10.5.

9. The preparation method according to claim 6, wherein the reducing agent is one or more selected from the group consisting of powdered carbon, pulverized coal, carbon monoxide, hydrogen, and hydrogen sulfide; and preferably, the reaction of the aluminum hydroxide with the reducing agent is conducted at 600° C. to 1,100° C.

10. Use of the sintering-resistant material according to claim 1 in the recycling of a scrapped power battery.

11. Use of the sintering-resistant material according to claim 2 in the recycling of a scrapped power battery.

12. Use of the sintering-resistant material according to claim 3 in the recycling of a scrapped power battery.

13. Use of the sintering-resistant material according to claim 4 in the recycling of a scrapped power battery.

14. Use of the sintering-resistant material according to claim 5 in the recycling of a scrapped power battery.
